(19) United States
(12) Patent Application Publication
(10) Pub. No.: US 2010/0042661 A1
(43) Pub. Date: Feb. 18, 2010

(54) Rehosting Method Which Convert Mainframe System into Open System

(75) Inventors: Kang Ho Lee, Seoul (KR); Jong Seung Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SAMSUNG SDS CO., LTD., Seoul (KR)

(21) Appl. No.: 12/445,569

(22) PCT Filed: Dec. 8, 2006
(86) PCT No.: PCT/KR2006/005335

§ 371 Date: Oct. 21, 2009

(30) Foreign Application Priority Data
Oct. 27, 2006 (KR) 10-2006-0105123

(51) Int. Cl. G06F 17/30

(52) U.S. Cl. 707/204; 707/E17.007

(57) ABSTRACT

Provided is a rehosting method for converting a mainframe system environment into an open system environment. The rehosting method rebuilds hardware (HAV) and software (SAV) of a company-data processing mainframe system environment to be appropriate for an open system environment, converts data included in a database or a general file to be appropriate for the open system environment, and reuses an application program. Thus, the rehosting method can be implemented at low cost within a short time and can significantly reduce maintenance cost.

### TECHNICAL FIELD

The present invention relates to a rehosting method and, more particularly, to a rehosting method that rebuilds hardware (H/W) and software (S/W) of a company-data processing mainframe system environment to be appropriate for an open system, converts data included in a database or a general file to be appropriate for the open system, and reuses an application program, and thus is capable of being implemented at low cost within a short time and significantly reducing maintenance cost.

### BACKGROUND ART

In general, mainframe systems have been used to process data within large corporations and governmental organizations.

The term, mainframe system, is industrial terminology indicating a large-scale computer manufactured by a large company, e.g., IBM Corporation. Mainframe systems are mainly used for performing computations required for the business activities of large companies, such as large corporations and financial institutions, and are configured according to a centralized, rather than distributed, computing method.

The cost of such a mainframe system is high and rapidly increases every year. For this reason, mainframe system environments are recently being replaced by open system environments, e.g., UNIX or Linux, which are designed to enable linkage between hardware (H/W) and software (S/W) of different computer manufacturing companies, and so on.

However, totally reestablishing a conventionally used mainframe system environment as an open system environment is very costly and takes a long time.

### DISCLOSURE OF INVENTION

### Technical Problem

The present invention is directed to a rehosting method rebuilding hardware (H/W) and software (S/W) of a mainframe system environment to be appropriate for an open system environment, converting data included in a database or a general file to be appropriate for the open system environment, and reusing an application program.

The present invention is also directed to a rehosting method that can be implemented at low cost within a short time and converts a mainframe system environment into an open system environment significantly reducing maintenance cost.

### Technical Solution

The term “rehosting”, used throughout this application, designates operations of, when converting a mainframe system environment into an open system environment, rebuilding hardware (H/W) and software (S/W) of the conventional mainframe system environment to be appropriate for the open system environment, converting data included in a database or a general file to be appropriate for the open system environment, and reusing an application program using middleware, a compiler solution, etc., instead of rebuilding the whole system.

One aspect of the present invention provides a rehosting method for converting a mainframe system environment into an open system environment, the rehosting method comprising the steps of: (a) customizing architecture, monitoring, backup, security, and administration tools of an open system being converted and configuring internal and external channel link environments; (b) performing a migration operation of data and an application program source; (c) checking a function and compatibility of an application program; and (d) checking performance and improvement for a load and an appropriate response speed of the open system being converted.

Here, the mainframe system may be a mainframe environment of IBM Corporation, and the open system may be a UNIX environment.

Step (a) may further comprise the step of setting an administration system according to an operating standard of the open system.

In step (b), the migration operation of data and an application program source may include an operation of converting data of a database, a virtual storage access method (VSAM) file, a sequential access method (SAM) file, or a tape file and a program conversion operation according to online/batch classification and an application program language.

In step (c), verification of an online/batch value, checking of results and data before and after a combination process, checking of compatibility of a program source process and change, and checking of functional compatibility of a converted utility and tool may be performed.

After step (d), the rehosting method may further comprise the step of checking and improving online/batch application performance and checking internal and external links to ensure performance of the application.

Another aspect of the present invention provides a recording medium storing a program for executing the above-described rehosting method for converting a mainframe system environment into an open system environment.

### Advantageous Effects

The inventive rehosting method for converting a mainframe system environment into an open system environment rebuilds hardware (H/W) and software (S/W) of a company-data processing mainframe system environment to be appropriate for an open system environment, converts data included in a database or a general file to be appropriate for the open system environment, and reuses an application program. Consequently, the inventive rehosting method can be implemented at low cost within a short time in comparison with a conventional method of totally rebuilding a mainframe system, and can significantly reduce maintenance cost.

### BRIEF DESCRIPTION OF THE DRAWINGS

FIG. 1 is a block diagram showing constitutions of systems to conceptually illustrate a rehosting method for converting a mainframe system environment into an open system environment according to an exemplary embodiment of the present invention;

FIG. 2 is a flowchart illustrating a rehosting method for converting a mainframe system environment into an open system environment according to an exemplary embodiment of the present invention;

FIG. 3 is a flowchart illustrating in detail a compatibility checking step of FIG. 2; and

FIG. 4 is a flowchart illustrating in detail a performance improving step of FIG. 2.

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

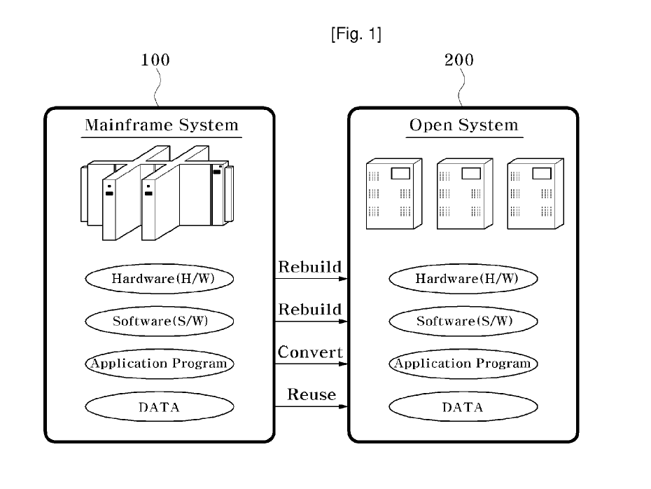

FIG. 1 is a block diagram showing constitutions of systems to conceptually illustrate a rehosting method for converting a mainframe system environment into an open system environment according to an exemplary embodiment of the present invention.

Referring to FIG. 1, a mainframe system 100 processing data of a company is industrial terminology indicating a large scale computer manufactured by a large company, e.g., IBM Corporation. The mainframe system 100 is mainly used for performing computations required for the business activities of large companies, such as large corporations and financial institutions, and is configured according to a centralized, rather than distributed, computing method.

Meanwhile, an open system 200 is industrial terminology indicating a method designed for enabling a link between hardware (H/W) and software (S/W) of different computer manufacturing companies, and is capable of being classified according to operating system, communication technique, and so on. The open system 200 mentioned here is a medium-scale computer having an operating system, e.g., UNIX, Linux, or so on.

When converting the environment of the mainframe system 100 into the environment of the open system 200, the present invention rebuilds H/W and S/W of the environment of the conventional mainframe system 100 to be appropriate for a UNIX system environment, converts data, which includes a database and a general file, to be appropriate for the open system environment, and reuses an application program using middleware, a compiler solution, etc., instead of rebuilding the entire system. Thus, in comparison with a conventional method of totally rebuilding a mainframe system environment into an open system environment, the present invention can be implemented at low cost within a short time and can significantly reduce maintenance cost.

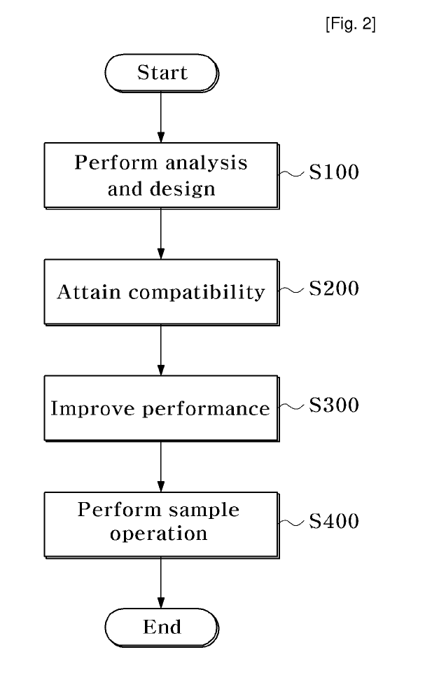

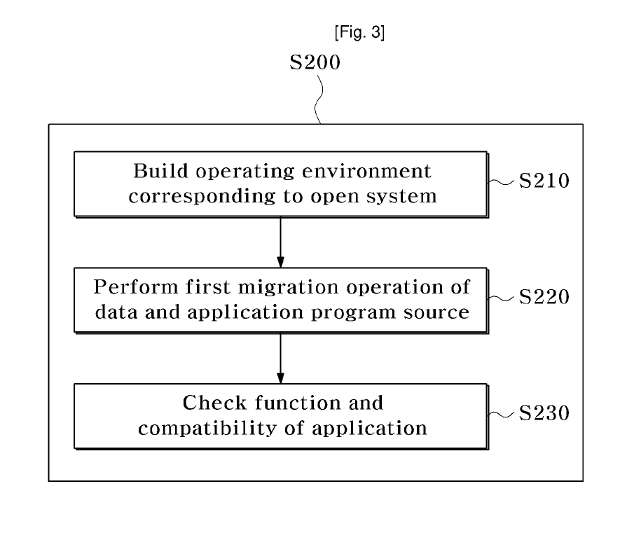

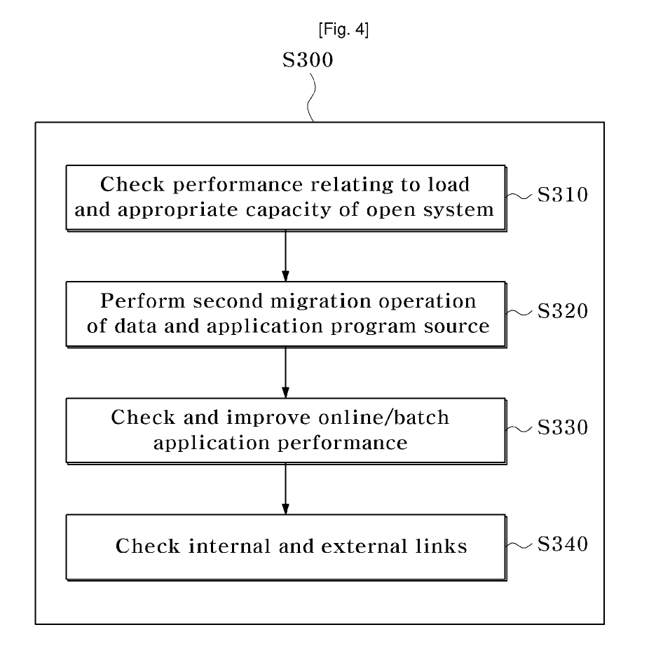

FIG. 2 is a flowchart illustrating a rehosting method for converting a mainframe system environment into an open system environment according to an exemplary embodiment of the present invention. FIG. 3 is a flowchart illustrating in detail a compatibility checking step of FIG. 2, and FIG. 4 is a flowchart illustrating in detail a performance improving step of FIG. 2.

Referring to FIG. 2, first, the overall present operating status of the current mainframe system 100 (refer to FIG. 1) is analyzed and designed (step 100).

Here, the overall present operating status includes, e.g., a present architecture status, an operating system, a middleware function, a database management system (DBMS), a business recovery system (BRS), an online/batch process environment, an application, a programming language, change management, a utility to which a package is applied or which is being used, and so on.

In step 100, e.g., a system environment, migration of data and an application program source, etc., are designed.

More specifically, in step 100, analysis for applying the present operating status of the currently used mainframe system 100 and a rehosting solution enables building of a development environment and designing of a blueprint, a detailed strategy for implementation, and an influence range of change/development. In addition, step 100 is a consulting step of theoretically performing and examining a building process on the basis of lessons learned from performing a past rehosting project before actually performing the building process.

In such a consulting step, the current system is analyzed, application of requirements and a solution are analyzed, a rehosting implementation plan is devised, a system environment is designed, and migration of data and an application program source is designed.

The current system analysis is a process of analyzing the present status of the currently used mainframe system, in which present condition analysis, e.g., a present architecture, an operating system, a middleware function, a DBMS, a BRS, etc., of an operation system and analysis of a development section environment and function, e.g., a programming language, the present status of applying a package, an online/batch environment, the present status of an application, change management, a used utility, etc., are performed.

In the application analysis of requirements and a solution, user requirements and application of the same are analyzed, a project risk factor is selected, application of the solution is verified, and so on.

Here, in the analysis of user requirements and application of the same, user requirements and a gap are analyzed, a function to which no solution will be applied is analyzed, and capacity and cost are analyzed, e.g., system capacity, data capacity, etc.

In the solution application verification, tool list-up is performed according to M/F-corresponding function enterprises and functions, and an essential requirement of each function for a necessary tool is defined.

In the devising of a rehosting implementation plan, the user requirements and the present status are analyzed and arranged, a blueprint and detailed strategy for implementation are designed, an influence range of change/development is deduced and examined, a method of overcoming project risk and a method of applying the solution are examined, and so on.

In the system environment design, To-Be architecture, e.g., a system, middleware, a DBMS, hardware, software, a network (N/W), a channel interface, backup, fault recovery, etc., is designed, a system installation plan is devised, e.g., ensuring infrastructure such as power, space, etc., relating to installation in advance, a 3rd tool is selected, e.g., list-up of software such as a system software, security, a monitoring/problem resolution tool, a DBMS utility, etc., required for respective functions, a development environment is built, and so on.

In the migration design of data and an application program source, a conversion plan for data, e.g., a database, a virtual storage access method (VSAM) file, a sequential access method (SAM) file, a tape, etc., is devised, a 3rd tool, e.g., a development tool, a debugging tool, a monitoring tool, etc., is selected, program conversion, e.g., definition of an object for conversion, conversion flow design, compiler option definition, etc., is designed, common development matters, such as a program identification (ID), a naming rule, etc., are defined, it is examined whether or not to additionally apply a special function, e.g., use of a 3270 screen, COOL:Gen, a network based storage management (NBSM) module, etc., and so on.

Meanwhile, application/data types that must be considered in the migration design of data and an application program source are as follows: a source program, e.g., a case in which a source module/secure sockets layer (SSL) does not exist, a partial generic model (PGM) source logic error, an unused PGM, a procedure information mistake, discordance between a transmitter identification (TxID) and a process group identification (PgID), etc.; a problem due to difference in compiler; a compile option, e.g., ANSI MODE, DIVIDED BY ZERO, NULL FETCH, etc.; a problem due to a database, i.e., definition of a data type, e.g., char type, numeric type, packed decimal, graphic, null process, etc., and database return code mapping, etc.; a problem in a conversion process, i.e., difference in order between Extended Binary Coded Decimal Interchange Code (EBCDIC) and American Standard Code for Information Interchange (ASCII) code, e.g., a condition value in a PGM, a screen display sequence, etc., inclusion of a special character, e.g., shift out/shift in (SO/SI), hexadecimal, etc./broken character, which cannot be converted, 1 and 2 byte conversion by a Korean character processing method, e.g., SO/SI process, adjustment of Korean character digit numbers, breaking down of letters, a graphic type, a substr/mid function, etc., space, full-width/half-width, Null process, etc.; internal and external module link, e.g., rule system link, batch type online (BTO) link, whether or not to delete a CANCEL text, whether or not there is a EBCDIC/ASCII conversion module, whether or not there is a full-width/half-width conversion module, whether or not to compel SO/SI to be added, etc.; and so on.

Step 200 is a process of attaining compatibility. In step 200, as illustrated in FIG. 3, operating environments corresponding to the open system 200 on conversion (refer to FIG. 1) are built on the basis of the present operating conditions of the mainframe system 100 analyzed and designed in step 100 (step 210), a first migration operation of data and an application program source is performed (step 220), and thereby a function and compatibility of the application are checked (step 230).

Here, the operating environments corresponding to the open system 200 include customizing of, e.g., architecture, monitoring, backup, security, and administration tools, or an internal and external channel, e.g., various affiliated organizations, an automatic response service (ARS), a call center, a cash dispenser/automatic teller machine (CD/ATM), etc., link environment, and so on.

In addition, in the first migration operation of data and an application program source (step 220), an operation of converting data of, e.g., a database, a VSAM file, a SAM file, or a tape, and a program converting operation according to online/batch classification and an application program language, are performed.

In addition, in the step of checking a function and compatibility of the application (step 230), verification of an online/batch value, checking of results and data before and after a combination process, checking of compatibility of a program source process and change, and checking of functional compatibility of a converted utility and tool, etc. are performed.

Additionally, a process of setting an administration system according to an operating standard of the open system 200 may be included.

More specifically, the compatibility checking step (step 200) is a first step in an actual building process, in which system and infrastructure operating environments, e.g., a server, a utility, a tool, etc., are built, and compatibility is checked and complemented by the first migration operation of data and an application program source.

First, operating environments of the open system 200 on conversion are built. To be specific, operation/development environments, e.g., an architecture, etc., corresponding to a new environment are built, monitoring, backup, security and operation tools are customized, e.g., batch schedule, sort, load, unload, database log extraction, security, printer, backup, monitoring, business recovery, tape management, etc., and then internal and external channel link environments are built.

Subsequently, a management system is built. To be specific, an administration system, e.g., a standard and procedure for change, a development tool, etc., is set up, a management/operation system of a DBMS is built, a server/database/solution environment is optimized, e.g., middleware environment analysis and plan devising (Tx performing process analysis, region design, and a problem analyzing method), and Oracle environment analysis and plan devising (a real application cluster, an initial parameter, disk management, and input/output (I/O) dispersion), etc.

Finally, the application program is converted, and compatibility thereof is checked. To be specific, the first migration operation of data and an application program source, e.g., data conversion and compatibility examination of a database, a VSAM file, a SAM file, a tape file, etc., and program conversion according to online/batch classification and a programming language, etc., is performed, and then an application function and compatibility are examined, e.g., verification of a result value per online/batch PGM unit source, checking of a main account module, checking of results and data before and after the combination process, checking of compatibility of a program source process and change relating to EBCDIC versus ASCII, difference in database, change in Korean character size, etc., checking of functional compatibility of a converted utility and tool such as SORT/LOAD/UNLOAD, etc.

Step 300 is a step of improving performance. In step 300, as illustrated in FIG. 4, performance relating to a load and appropriate capacity of the open system 200 built in step 200 are checked (step 310), and a second migration operation of data and an application program source is performed to ensure performance of the application (step 320).

Additionally, in order to ensure performance of the application, online/batch application performance may be checked and improved (step 330), and internal and external links may be checked (step 340).

More specifically, the performance improving step (step 300) is a second iteration step, in which a tuning and redevelopment operation is performed to check performance of the newly converted open system 200 and ensure performance of the application.

First, configuration of operating environments is completed. To be specific, tuning and optimization of the system, middleware, and the DBMS are performed by, e.g., tuning a hardware structure and middleware performance.

Subsequently, environments of the newly converted open system 200 are built. To be specific, after other architectures, e.g., a verification system, a batch system, an external relation system, a managing system, a backup system, etc., excluding operation/development environments, are built, building of the operating environments, e.g., system/database parameter optimization, a change management system, resource allocation, monitoring, a BRS, security, etc., is completed.

Then, configuration of the management system is completed. To be specific, operating environments, e.g., definition of a business system environment, application of PGM change management, monitoring, a development tool, internal and external channel link environments, etc., according to the operating standard are built.

Finally, performance of the application is improved. To be specific, after the second migration operation of data and an application program source is performed, performance of the online/batch application is examined and improved, e.g., deduction of a tuning point, a gap of difference in database, massive batch operation change for performance, tool link for performance improvement, etc., and internal and external links are checked, e.g., enterprise application integration (EAI), BYSYS, etc.

Step 400 is a step of performing a sample operation. In step 400, an overall examination is performed to ensure stable operation of the open system 200 built after the step of improving performance (step 300), and smooth maintenance.

More specifically, step 400 is a third iteration step of performing a sample operation before applying the new open system 200. In step 400, it is synthetically checked whether stable operation and smooth maintenance of the open system 200 are ensured or not, and operation after release, such as application education in the new environment, etc., is prepared.

First, a sample operation plan, e.g., a method and a schedule for examining compatibility and performance of online/batch/channel links, performing of other operation works, such as massive batch operations, and BTO, etc., is devised, and then it is switched to a management mode of the open system environment. To be specific, operation status check, e.g., daily routine maintenance, peak time monitoring, operation statistics, etc., fault and change management, e.g., change control, fault trace, history management, etc., application of an operating system, e.g., work scheduling and processing, input and undertaking of operating manpower, etc., etc., are performed.

Subsequently, the sample operation is performed. To be specific, after the third migration operation of data and an application program source is performed, an online/batch application field test is performed. Finally, application education, e.g., making and instructing an operation/development manual, educating a person in charge of application maintenance, etc., is performed.

Meanwhile, in steps 200 to 400, it is preferable to approach target levels using the iteration methods.

The above-described rehosting method, i.e., project, of converting a mainframe system environment into an open system environment according to an exemplary embodiment of the present invention mainly changes systems, such as a server, a database, an operating system, etc., rather than develops a business logic, unlike a general development method.

In addition, the present invention is not general application development undergoing processes of application analysis, design and development. The inventive rehosting development process progresses similar to a spiral model, so that risk can be minimized by adding risk analysis of a large-scale system and an iterative approach.

In addition, the present invention needs a consulting step using lessons learned so as to remove non-efficiency from an iterative development process, shorten a development period, and improve accuracy. Via the consulting process, characteristics of project-specific sites are individually analyzed, a possible problem is deduced in advance and prevented, and an efficient building course is searched to prevent repeating mistakes, thereby achieving a successful object within a predetermined time period.

Meanwhile, the rehosting method for converting a mainframe system environment into an open system environment according to an exemplary embodiment of the present invention can be stored on a computer-readable recording medium in the form of computer code. The computer-readable recording medium may be any recording device storing data that can be read by computer systems.

For example, the computer-readable recording medium may be a read-only memory (ROM), a random-access memory (RAM), a compact disk read-only memory (CD-ROM), a magnetic tape, a hard disk, a floppy disk, a mobile storage device, a nonvolatile memory (flash memory), an optical data storage device, and so on. Also, the recording medium may be carrier waves, e.g., transmission over the Internet.

In addition, the computer-readable recording medium may be distributed among computer systems connected via a communication network and stored in the form of a code that can be read and executed by a de-centralized method.

While the invention has been shown and described with reference to a certain exemplary embodiment of a rehosting method for converting a mainframe system environment into an open system environment, it will be understood by those skilled in the art that various changes in form and details may be made therein without departing from the spirit and scope of the invention as defined by the appended claims.

1. A rehosting method for converting a mainframe system environment into an open system environment, the method comprising the steps of:
(a) customizing architecture, monitoring, backup, security, and administration tools of an open system being converted and configuring internal and external channel link environments;
(b) performing a migration operation of data and an application program source;
(c) checking a function and compatibility of an application program; and
(d) checking performance for a load and an appropriate response speed of the open system being converted.

2. The method of claim 1, wherein the mainframe system is a mainframe environment of IBM Corporation, and the open system is a UNIX environment.

3. The method of claim 1, wherein step (a) further comprises a step of setting an administration system according to an operating standard of the open system.

4. The method of claim 1, wherein in step (b), the migration operation of data and an application program source comprises:
an operation of converting data of a database, a virtual storage access method (VSAM) file, a sequential access method (SAM) file, or a tape file; and
a program conversion operation according to online/batch classification and an application program language.

5. The method of claim 1, wherein in step (c), verification of an online/batch value, checking of results and data before and after a combination process, checking of compatibility of a program source process and change, and checking of functional compatibility of a converted utility and tool are performed.

6. The method of claim 1, after step (d), further comprising the step of:
checking and improving online/batch application performance and checking internal and external links to ensure performance of the application.

7. A computer-readable recording medium storing a program capable of executing the method of any one of claims 1 to 6.
